(19) United States
(12) Patent Application Publication
(10) Pub. No.: US 2003/0234548 A1
(43) Pub. Date: Dec. 25, 2003

(54) Wafer handler

(76) Inventor: Ravinder Aggarwal, Gilbert, AZ (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/179,736

(22) Filed: Jun. 24, 2002

(51) Int. Cl. B25J 15/06

(52) U.S. Cl. 294/64.1

(57) ABSTRACT

Manually operated wafer handlers are provided for handling and transporting semiconductor wafers. The wafer handlers contact the wafers only at the outer edges of the wafers, thereby preventing damage to the interior surfaces of the wafers on which integrated circuits are formed.

### FIELD OF THE INVENTION

The invention relates to wafer handlers for handling and transporting semiconductor wafers and, more particularly, to manually operated wafer handlers.

### BACKGROUND OF THE INVENTION

Wafer handlers are commonly used to transport wafers to and from wafer storage cassettes and between various wafer processing areas. Automated robotic wafer handlers are typically used for relatively large batch applications. Manually operated wafer handlers are often used in laboratory and small batch applications.

One common type of wafer handler uses vacuum pressure to hold the wafers in place during transport. Such wafer handlers typically comprise a wafer contact surface having vacuum ports formed therein. The vacuum ports are in fluid communication with a vacuum source, such as a pump. The handlers typically comprise means to increase the strength of the vacuum applied at the vacuum ports to secure the wafer to the handler during transport of the wafers, and decrease the strength of the vacuum applied at the vacuum ports to release the wafer from the handler.

Manually operated vacuum wafer handlers typically contact the wafers at the center or interior of the wafers. Central or interior support of the wafers by the handlers is considered necessary for stability during manual handling of the wafers. This central or interior contact, however, can leave marks or scratches on the interior surfaces of the wafers on which the integrated circuits are formed, thereby damaging the wafers. In addition, because the wafer handlers are intended to contact the wafers at the center or interior of the wafers, the wafer handlers must be slid alongside the wafers to reach the interior of the wafers. This can be difficult when the wafers are supported in standard wafer cassettes, in which the pitch or distance between the wafers is relatively small. Furthermore, because the wafer handlers must be slid between the wafers in the cassettes, it is often difficult to load and unload the wafers from the cassettes without scraping the wafers on the supports of the cassettes, thereby further damaging the wafers.

### SUMMARY OF THE INVENTION

The preferred embodiments of the present invention overcome the problems of the prior art by providing wafer handlers that contact the wafers only at the outer peripheral edge, or “exclusion zone,” of the wafers, thereby preventing damage to the interior surface of the wafers on which the integrated circuits, or structures therefor, are formed or to be formed.

In accordance with one aspect of the present invention, an apparatus for manually transporting a semiconductor wafer is provided. The apparatus comprises a handle and a grip portion at an end of the handle. The grip portion is adapted to extend along a peripheral edge of the wafer and has an upper surface for supporting the wafer. The upper surface has a plurality of vacuum ports therein.

In accordance with another aspect of the present invention, an apparatus for transporting a semiconductor wafer is provided. The apparatus comprises a handle and a grip portion at an end of the handle. The grip portion has a recessed area in an upper surface thereof. A plurality of vacuum ports are provided in the upper surface of the recessed area.

In accordance with another aspect of the present invention, an apparatus for transporting a semiconductor wafer is provided. The apparatus comprises a handle and a grip portion having a plurality of vacuum ports therein. The vacuum ports generally lie on a circle having a diameter slightly less than a diameter of the wafer.

In accordance with another aspect of the present invention, an apparatus for transporting a semiconductor wafer is provided. The apparatus comprises a handle and a grip portion at an end of the handle. The grip portion comprises a main body and a plurality of fingers extending from the main body. The grip portion has a plurality of vacuum ports in an upper surface thereof and a wafer support adjacent each of the vacuum ports. The wafer supports are arranged to contact the wafer at an edge of the wafer.

### BRIEF DESCRIPTION OF THE DRAWINGS

These and other aspects of the invention will be readily apparent to the skilled artisan in view of the description below, the appended claims, and from the drawings, which are intended to illustrate and not to limit the invention, and wherein:

FIG. 1 is a perspective view of one embodiment of a vacuum wand having certain features and advantages in accordance with the present invention;

FIG. 2 is a top plan view of the vacuum wand of FIG. 1;

FIG. 3 is a perspective view of another embodiment of a vacuum wand having certain features and advantages in accordance with the present invention; and

FIG. 4 is a top plan view of the vacuum wand of FIG. 3.

### DETAILED DESCRIPTION OF THE PREFERRED EMBODIMENTS

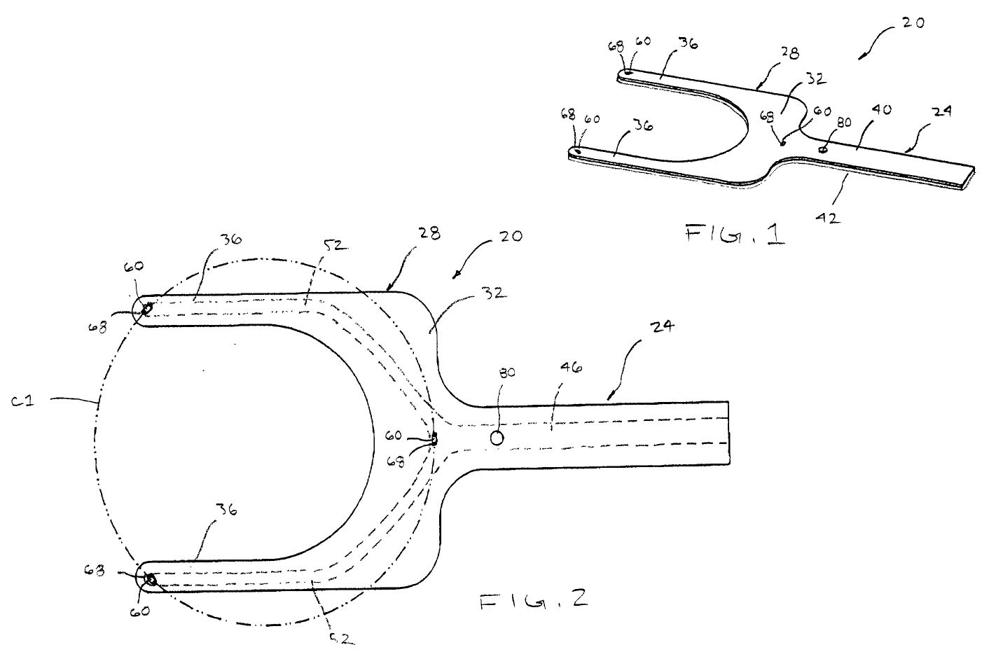

One embodiment of a wafer handler 20 having certain features and advantages in accordance with the present invention is illustrated in FIGS. 1 and 2. With reference to FIG. 1, in the illustrated embodiment, the wafer handler 20 generally comprises a handle 24 and a grip portion 28 at an end of the handle 24. Note that “handle,” as used herein, refers to a part suitable for gripping by a human hand and free at one end such that the wafer handler 20 can be manually employed. The grip portion 28 includes a main body 32 that extends in a direction generally perpendicular to the handle 24 and a plurality of fingers 36 that extend generally parallel to the handle 24 from the main body 32. In the illustrated embodiment, the grip portion 28 includes two fingers 36, one at each side of the main body 32.

The wafer handler 20 preferably is generally planar and is relatively thin to facilitate sliding the handler 20 between wafers in a standard wafer cassette. The width of the grip portion 28 preferably is slightly less than the distance between the supports of the cassette that extend beneath the edges of the wafers to support the wafers. In the illustrated embodiment, the wafer handler 20 is configured to transport 300 mm wafers. Accordingly, the width of the grip portion 28 between the outer edges of the fingers 36 is preferably less than about 260 mm, and in the illustrated embodiment is 150 mm. Those skilled in the art will appreciate, however, that the optimal size of the grip portion 28 will depend on the diameter of the wafers to be transported with the handler 20.

With reference to FIG. 1, in the illustrated embodiment, the wafer handler 20 comprises a top member 40 and a bottom member 42 which is bonded or otherwise secured to the top member 40. As illustrated in FIG. 2, a gas passage 46 is provided through the handler 20 between the top and bottom members 40, 42. The gas passage 46 can be created, for example, by forming a groove in either the top member 40 or the bottom member 42 prior to securing the top and bottom members 40, 42 together. The gas passage 46 extends through the handle 24 of the wafer handler 20 and splits into two branches 52 at the main body 32 of the grip portion 28. The branches 52 extend through the fingers 36 of the grip portion 28.

With reference to FIG. 2, vacuum ports 60 are provided in the grip portion 28 of the wafer handler 20. In the illustrated embodiment, the wafer handler 20 includes three vacuum ports 60. A first vacuum port 60 is provided in the main body 32 of the grip portion 28. Second and third vacuum ports 60 are provided near the ends of the fingers 36. The vacuum ports 60 comprise openings that extend from the gas passage 46 through the top member 40 of the handler 20.

As is apparent from FIG. 2, in the illustrated embodiment, the vacuum ports 60 are arranged to generally lie on a circle C1 having a diameter less than the diameter of the wafers to be transported with the handler 20. Preferably, the diameter of the circle C1 is between about 0.2 mm and 10 mm less than the diameter of the wafers to be transported. More preferably, the diameter of the circle C1 is between about 0.4 mm and 5 mm less than the diameter of the wafers to be transported. Thus, if the wafer handler 20 is configured to transport 300 mm wafers, as in the illustrated embodiment, the diameter of the circle C1 is preferably between about 290 mm and 299.8 mm, and more preferably between about 295 mm and 299.6 mm.

As illustrated in FIG. 2, a wafer support 68 is provided adjacent each of the vacuum ports 60. The wafer supports 68 extend above the upper surface of the top member 40 and preferably surround the vacuum ports 60. The supports 68 can be formed integrally with the top member 40 or bonded to the upper surface of the top member 40, and are preferably either made of, or coated with, TEFLON®, VESPEL®, or a similar low-friction material. The wafer supports 60 are arranged so that, when a wafer is properly situated on the grip portion 28, the wafer supports 68 contact only the peripheral edge of the wafer. Preferably, the wafer supports 68 are arranged to contact the wafer no more than about 5 mm from the edge of the wafer, and more preferably no more than about 3 mm from the edge of the wafer.

A vacuum line (not shown) preferably is connected to the handle 24 at a rear of the gas passage 46. The vacuum line extends between the wafer handler 20 and a pump (not shown) or other vacuum source. The vacuum ports 60 are thus in fluid communication with the pump via the gas passage 46 and the vacuum line.

In the wafer handler 20 of FIGS. 1 and 2, a vacuum release opening 80 is provided near an end of the handle 24 adjacent the grip portion 28. The vacuum release opening 80 extends into the gas passage 46 through the top member 40 of the handler 20. As will be appreciated by those skilled in the art, the strength of the vacuum delivered to the vacuum ports 60 is increased when the release opening 80 is obstructed, for example, by the thumb of the operator, and decreased when the release opening 80 is unobstructed. Thus, when the operator desires to grasp a wafer, the grip portion 28 of the handler 20 is slid beneath the wafer with the release opening 80 unobstructed so that the wafer supports 68 are positioned at the peripheral edge of the wafer. The release opening 80 is then covered, for example, by the thumb of the operator. Alternatively, the wafer handler 20 may be equipped, for example, with a cover (not shown) that the operator can slide, rotate or lower onto the release opening 80 to obstruct the opening 80. When the release opening 80 is covered, the vacuum applied at the vacuum ports 60 retains the wafer against the wafer supports 68. The wafer can then be safely transported with the wafer handler 20. To release the wafer from the handler 20, the vacuum release opening 80 is uncovered and the grip portion 28 is slid out from beneath the wafer.

Because the wafer supports 68 of the handler 20 of FIGS. 1 and 2 are raised above the upper surface of the top member 40, the wafers do not contact the upper surface of the top member 40. The wafers are contacted only by the wafer supports 68. Since the wafer supports 68 are arranged to contact only the edge exclusion zone of the wafer, damage to the interior of the wafer, on which the integrated circuits are formed or to be formed, is prevented.

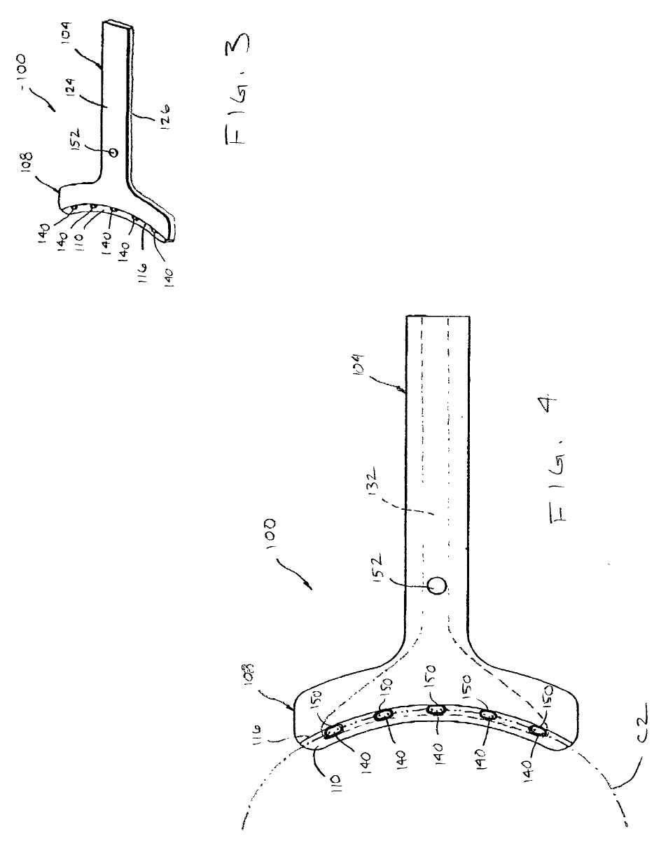

With reference now to FIGS. 3 and 4, a second embodiment of a wafer handler 100 having certain features and advantages in accordance with the present invention is illustrated. The wafer handler 100 of FIGS. 3 and 4 generally comprises a handle 104 and a grip portion 108 at an end of the handle 104.

A recessed area 110 is provided at an end of the grip portion 108. In the illustrated embodiment, the recessed area 110 comprises an arc-shaped surface for supporting the wafers. A wall 116 is formed where the recessed area 110 meets the rest of the grip portion 108. The width of the recessed area 110 between the wall 116 and the side of the recessed area 110 opposite the wall 116 is preferably between about 5 mm and 10 mm. Accordingly, when a wafer is positioned on the recessed area 110 so that the edge of the wafer abuts the wall 116, the recessed area 110 preferably extends inwardly from the edge of the wafer towards the center of the wafer less than about 10 mm.

Preferably, the recessed area 110 is sized to extend along the edges of the wafers about 90°. The grip portion 108 preferably is as long as possible without interfering with the sides of the wafer cassette during loading or removal of the wafers. As will be appreciated by those skilled in the art, as the length of the recessed area 110 is decreased, the width of the recessed area 110 and/or the strength of the vacuum required to hold the wafer in place at the end of the wafer handler 100 are increased. Conversely, as the width of the recessed area 110 is decreased, the length of the recessed area 110 and/or the strength of the vacuum required to hold the wafer in place are increased.

Like the wafer handler 20 of FIGS. 1 and 2, the wafer handler 110 illustrated in FIGS. 3 and 4 preferably comprises a top member 124 and a bottom member 126 which is bonded or otherwise secured to the top member 124 (see FIG. 3). As illustrated in FIG. 4, a gas passage 132 is provided through the handler 100 between the top and bottom members 124, 126, preferably by forming a groove in either the top member 124 or the bottom member 126 prior to securing the top and bottom members 124, 126 together. The gas passage 132 extends through the handle 104 of the wafer handler 100 and through the grip portion 108 to the recessed area 110.

With reference to FIG. 4, a plurality of vacuum ports 140 are provided in the recessed area 110 of the grip portion 108. In the illustrated embodiment, five vacuum ports 140 are spaced apart along the recessed area 110. Those skilled in the art will appreciate, however, that a greater or lesser number of vacuum ports 140 may be provided, as necessary, to hold the wafers in place against the recessed area 110. The vacuum ports 140 comprise openings that extend into the gas passage 132 through the top member 124 of the handler 100. In the illustrated embodiment, the gas passage widens towards the recessed area 110 to communicate with all of the vacuum ports 140. Alternatively, however, the gas passage 132 may be divided into branches near the recessed area 110, so that each of the branches communicates with only one or some portion of the vacuum ports 140.

As in the embodiment of FIGS. 1 and 2, the vacuum ports 140 of the wafer handler 100 of FIGS. 3 and 4 preferably are arranged to generally lie on a circle C2 having a diameter less than or equal to the diameter of the wafers to be transported with the handler 100. Preferably, the diameter of the circle C2 is between about 0.2 mm and 10 mm less than the diameter of the wafers to be transported. More preferably, the diameter of the circle C2 is between about 0.4 mm and 5 mm less than the diameter of the wafers to be transported. Accordingly, if the wafer handler 100 is configured to transport 300 mm wafers, as in the illustrated embodiment, the diameter of the circle C2 is preferably between about 290 mm and 299.8 mm, and more preferably between about 295 mm and 299.6 mm.

As illustrated in FIG. 4, a wafer support 150 is provided adjacent each of the vacuum ports 140. The wafer supports 150 extend above the upper surface of the recessed area 110 and preferably surround the vacuum ports 140. The supports 150 can be formed integrally with the recessed area 110 or bonded to the upper surface of the recessed area 110, and are preferably either made of, or coated with, TEFLON®, VESPEL®, or a similar low-friction material. The wafer supports 150 are arranged so that, when a wafer is properly situated on the recessed area 110, the wafer supports 150 contact only the peripheral edge of the wafer. Preferably, the wafer supports 150 are arranged to contact the wafer no more than about 5 mm from the edge of the wafer, and more preferably no more than about 3 mm from the edge of the wafer.

A vacuum line (not shown) preferably is connected to the handle 104 of the wafer handler 110 at a rear of the gas passage 132. The vacuum line extends between the wafer handler 100 and a pump (not shown) or other vacuum source. The vacuum ports 140 are thus in fluid communication with the pump via the gas passage 132 and the vacuum line.

With reference still to FIG. 4, a vacuum release opening 152 is provided near an end of the handle 104 adjacent the grip portion 108. The vacuum release opening 152 extends into the gas passage 132 through the top member 124 of the handler 100. When the operator desires to grasp a wafer, the recessed area 110 of the grip portion 108 is slid beneath the wafer with the release opening 152 unobstructed until the wall 116 between the recessed area 110 and the rest of the grip portion 108 abuts the edge of the wafer. The wall 116 thus helps to ensure that the wafer handler 100 is properly positioned with respect to the wafer. The vacuum release opening 152 is then covered, for example, by the thumb of the operator. Alternatively, the wafer handler 100 may be equipped, for example, with a cover (not shown) that the operator can slide, rotate or lower onto the release opening 152 to obstruct the opening 152. When the release opening 152 is obstructed, the wafer is supported on the recessed area 110 while the vacuum applied at the vacuum ports 140 retains the wafer in place. The wafer can then be safely transported with the wafer handler 100. To release the wafer from the handler 100, the release opening 152 is uncovered and the recessed area 110 is slid out from beneath the wafer. Because the recessed area 110 is relatively narrow, only the edge exclusion zone of the wafer is contacted by the wafer handler 100. Damage to the interior of the wafer is thereby prevented.

In standard wafer cassettes or front-opening unified pods (“FOUPs”), the front portions of the wafers are easily accessible. One advantage of the wafer handler 100 of FIGS. 3 and 4 is that only the recessed area 110 of the grip portion 108, which is relatively narrow, is slid beneath a wafers to support the wafer. Because the wafer handler 100 is slid beneath only the edge on one side of the wafer, the likelihood of the handler 100 marking or scratching the interior surface of the wafer is eliminated. Furthermore, since the recessed area 110 preferably extends only about 90° around the edge of the wafer, the wafer handler 100 can easily access the front portions of the wafers in standard wafer cassettes or FOUPs.

It should be noted that certain objects and advantages of the invention have been described above for the purpose of describing the invention and the advantages achieved over the prior art. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Moreover, although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. It is further contemplated that various combinations and sub-combinations of the specific features and aspects of the embodiments may be made and still fall within the scope of the invention. Accordingly, it is intended that the scope of the present invention herein disclosed should not be limited by the particular disclosed embodiments described above, but should be determined only by a fair reading of the claims that follow.

I claim:

1. An apparatus for manually transporting a semiconductor wafer, comprising:
a handle; and
a grip portion at an end of the handle, the grip portion adapted to extend along a peripheral edge of the wafer and having an upper surface for supporting the wafer, the upper surface having a plurality of vacuum ports therein.

2. The apparatus of claim 1, wherein the grip portion includes a recessed area at a front end of the grip portion, the recessed area shaped to accommodate the peripheral edge of the wafer.

3. The apparatus of claim 2, wherein the upper surface of the recessed area is sized to extend inwardly from the peripheral edge of the wafer towards the center of the wafer less than about 5 mm.

4. The apparatus of claim 2, wherein the upper surface of the recessed area is sized to extend inwardly from the peripheral edge of the wafer towards the center of the wafer less than about 3 mm.

5. The apparatus of claim 2, further comprising a gas passage extending along the handle and the grip portion, the vacuum ports being in fluid communication with the gas passage.

6. The apparatus of claim 5, further comprising a vacuum release opening in fluid communication with the gas passage, the release opening adapted to be manually obstructed by a user to increase a strength of a vacuum applied at the vacuum ports.

7. An apparatus for transporting a semiconductor wafer, comprising:
a handle;
a grip portion at an end of the handle, the grip portion having a recessed area in an upper surface thereof and a plurality of vacuum ports in an upper surface of the recessed area.

8. The apparatus of claim 7, wherein the handle includes a vacuum release opening

9. The apparatus of claim 8, wherein the vacuum release opening can be manually obstructed to selectively increase a vacuum strength delivered at the vacuum ports.

10. The apparatus of claim 7, wherein the recessed area comprises a generally arc-shaped surface.

11. The apparatus of claim 10, wherein the recessed area is sized to extend about 90 degrees along the edge of the wafer.

12. The apparatus of claim 10, wherein a wall is formed between the recessed area and the rest of the grip portion.

13. The apparatus of claim 12, wherein a width of the recessed area between the wall and a side of the recessed area opposite the wall is between about 5 mm and 10 mm.

14. The apparatus of claim 7, further comprising a wafer support adjacent each of the vacuum ports, the wafer supports extending above an upper surface of the recessed area.

15. The apparatus of claim 14, wherein the wafer supports are formed integrally with the recessed area.

16. The apparatus of claim 14, wherein the wafer supports are bonded to an upper surface of the recessed portion.

17. An apparatus for transporting a semiconductor wafer, comprising:
a handle; and
a grip portion having a plurality of vacuum ports therein, the vacuum ports generally lying on a circle having a diameter slightly less than a diameter of the wafer.

18. The apparatus of claim 17, wherein the diameter of the circle is between about 0.2 mm and 10 mm less than the diameter of the wafer.

19. The apparatus of claim 18, wherein the diameter of the circle is between about 290 mm and 299.8 mm.

20. The apparatus of claim 17, wherein the diameter of the circle is between about 0.4 mm and 5 mm less than the diameter of the wafer.

21. The apparatus of claim 20, wherein the diameter of the circle is between about 295 mm and 299.6 mm.

22. The apparatus of claim 17, wherein the grip portion comprises a main body and a plurality of fingers extending from the main body, the vacuum ports being formed in an upper surface of the main body and an upper surface of each of the fingers.

23. The apparatus of claim 22, further comprising a wafer support provided adjacent each of the vacuum ports.

24. The apparatus of claim 17, wherein the grip portion comprises an arc-shaped surface adapted to extend along a peripheral edge of the wafer.

25. An apparatus for transporting a semiconductor wafer, comprising:
a handle; and
a grip portion at an end of the handle, the grip portion comprising a main body and a plurality of fingers extending from the main body, the grip portion having a plurality of vacuum ports in an upper surface thereof and a wafer support adjacent each of the vacuum ports, the wafer supports being arranged to contact the wafer only at an edge of the wafer.

26. The apparatus of claim 25, wherein the grip portion comprises two fingers.

27. The apparatus of claim 25, wherein the wafer supports extend above an upper surface of the main body and an upper surface of each of the fingers.

28. The apparatus of claim 27, wherein the wafer supports are coated with a low friction material.

29. The apparatus of claim 28, wherein the low friction material is TEFLON® or VESPEL®.

30. The apparatus of claim 25, wherein the wafer supports are arranged to contact the wafer no more than about 5 mm from the edge of the wafer.

31. The apparatus of claim 25, wherein the wafer supports are arranged to contact the wafer no more than about 3 mm from the edge of the wafer.

32. The apparatus of claim 25, further comprising a gas passage extending along the handle, the main body, and each of the fingers, the vacuum ports being in fluid communication with the gas passage.

33. The apparatus of claim 32, further comprising a vacuum release opening in fluid communication with the gas passage, the release opening adapted to be manually obstructed by a user to increase a strength of a vacuum applied at the vacuum ports.
